(19) United States
(12) Patent Application Publication
(10) Pub. No.: US 2011/0124318 A1
(43) Pub. Date: May 26, 2011

(54) System/method for wireless internet advertising utilizing GPS and/or an identifier code via smartphone/smart device interaction

(76) Inventor: Steven Curtis Ayer, Reno, NV (US)

(21) Appl. No.: 12/592,269

(22) Filed: Nov. 21, 2009

(51) Int. Cl. H04M 3/42; G06Q 30/00

(52) U.S. Cl. 455/414.1; 705/14.55; 705/14.64; 705/14.73

(57) ABSTRACT

An advanced advertising systems/method that is especially useful with billboard advertisements, physical location of business, TV ads, radio ads and/or local services that are available within a specified zone/area or specific vicinity. More specifically the invention relates to either a system/method that allows a user to easily obtain information via GPS location and/or an identifier code from an advertisement or the like via a Smartphone/Smart device or any other type of interactive apparatus.

### FIELD OF THE INVENTION

This invention relates in general too advanced advertising systems and/or methods that are especially useful with billboard advertisements, TV ads and/or local services that are available within a specified area and/or vicinity. More specifically the invention relates to either a system or method that allows a user to easily obtain information via GPS location and/or an identifier code from an advertisement or the like via a Smartphone, smart device or any other type of interactive apparatus.

### BACKGROUND OF THE INVENTION

It is well known while travelling along today's busy roadways that visually a driver and/or the occupant of a vehicle is constantly bombarded with advertising billboards and the like. Many times the driver/occupant may wish to read the advertisement and/or obtain the information disclosed thereon but this is impossible as the sign is quickly out of view before one can retrieve the information. This is also true for television viewers and radio listeners as most ads require one to immediately grab a pin/paper and/or remember the phone number before the information is forgotten. Furthermore, this is not only unfortunate for the onlooker/listener but more importantly the business associated with the advertisement does not profit because the consumer cannot retain the information quickly enough and thus they are not likely to engage in their services. As a result, billboard advertising, TV and radio commercials, are not effective, they are extremely inefficient and much too costly for the business. Thus, it has become apparent that there is a great need for businesses and billboard owners, radio and TV broadcasting companies to resolve the issue and provide the consumer with a means to easily obtain the information disclosed on the billboard, TV or radio ad in a simplified timely efficient manner. Today's consumer wants information immediately and the Smartphone/Smartdevice is the perfect way to accomplish this.

As a result, there have been numerous attempts within the prior art to resolve the problem such as exemplified within the following U.S. Patents.

U.S. Pat. Nos. 7,565,328, 7,457,628, 7,436,370, 6,714,860, 7,496,328, 7,548,874, 7,487,112 and 7,496,328 all propose to provide some type of advanced communication means for allowing one to interact with advertising media and businesses associated therewith. However, each of the cited references has proven to be much too complicated, require costly equipment, new technologies and they are simply not conceivably cost effective.

### OBJECTS AND ADVANTAGES OF THE PRESENT INVENTION

Nowhere in the known prior art did the applicant find any system/method that utilizes current existing technologies such as a Smartphone, smart device, GPS and/or an identifier code as taught within the present invention.

More importantly the present invention is a new and novel means for companies to market their products using Smart Phone and/or Smart Device technology. A vendor will now have the ability to combine all of their marketing efforts in one location, all of which will be easily available to clientele through direct marketing using a Smartphone application, GPS, technology, signage and also web interface for the vendor. Furthermore, the vendor will now have the ability to change advertising on the fly and have interactive capability. Also, billboard and sign advertising will change from tertiary type advertising to primary which is most advantageous.

Furthermore, the present invention allows the user to capture advertising information from any source of user choice, including any signs fixed or mobile, business location, event location, kiosk, radio, broadcast video, movie theatre and print advertising with the Smartphone/Smart-device if desired. The invention will allow the user to instantly capture advertising information locally using a single click. In the case of ads with no permanent physical location such as print ads, radio, broadcast video and mobile ads or the like, an identifier code can be utilized and the code simply entered for access. Also, radio and broadcast video ads can be searched for by date/time range, channel and medium.

As a result the present invention will revolutionize marketing in general. With the loss of newspapers and magazines and other advertising venues vendors want to successfully invest marketing dollars. Using this technology they will be able to place all of their advertising information at the fingertips of buyers. Bill board advertising will become a primary marketing tool where it has been considered tertiary until now. Entrepreneurs will have the ability to instantaneously adjust marketing strategies instead of waiting for the next ad to come out. No more wasted money advertising in places where the competitor advertises just because the competition advertises this way.

The present invention method will feature a search function where the user can specify search parameters for products and/or services they are looking for. This is a novel and unique feature of the system. Utilizing the GPS interface each of the ads associated with the system are designated into specific zones. For example, in congested areas having a multitude of ads therein, the specific zone is small, such as the size of a city square block. In other areas having lesser ads therein, the zone is larger, such as the zone may be of a one mile radius, 10 mile radius, or the like. Also, each of the zones are categorized and assigned a specific identifier, such as zone 1-A, 1-B, 1-C, or any other type of identification means of engineering choice.

Furthermore, another option is that while the search function is active it will continuously search until closed. This search function will collect and save advertising which corresponds and retain so the user can view the information when desired at their leisure when convenient. The present invention functions with either existing second party GPS software or proprietary GPS software and will directly link through web portal to websites, GPS mapping, phone numbers, email links, video, audio, streaming video, streaming audio, social networking sites or proprietary web interface. The Smartphone/Smart-device, GPS interaction and portal software in combination will identify the user, determine their location and correlate the data to establish communication between the user and any appropriate ads within the designated area. Rural areas will have larger capture areas and urban areas will be more restrictive. A further option allows the user to expand the search distance as well as provide other user options of choice. More importantly all advertising ads will have a specific logo/ID-code displayed thereon to notify the consumer that the ad is accessible via the current system. Another feature is to include an audio option that allows the user to listen to or be alerted to ads to avoid visual distractions if preferred.

Businesses will be able to utilize their store front and in house signage to provide consumers with much more advertising information and interact with clientele. The merchant can target markets in other areas and especially in high traffic-jam areas where drivers are captive prospects. Overall, the present invention with combined Smartphone/GPS technology will change the way consumers buy products and merchants effectively market their merchandise.

It is therefore a primary object of the present invention to provide a wireless internet advertising system/method that overcomes the many disadvantages associated with the known prior art.

It is another object of the present invention to provide a wireless internet advertising system/method that is cost effective, most efficient, simplified in use and resolves the problems inherent within the know prior art in a manner heretofore not taught or conceived.

Yet another object of the present invention is to provide a wireless internet advertising system/method that is advantageous for businesses, service providers, any and all advertising mediums and more importantly consumers.

Another very important object of the present invention is to provide a wireless internet advertising, system/method that does not necessitate any technology that is not readily available and no new equipment, computer programs, costly devices and/or accessories are required.

Still another important object of the present invention is to provide a wireless internet advertising system/method that allows the user to choose either visual display or an audio recording associated with the ad. This is most advantageous as visual display can sometimes be distracting and audio may be more convenient. Also, if desired while audio is utilized the entire process for the system/method can be operated by voice commands only. This is very novel and unique.

Another important object of the present invention is to provide a wireless internet advertising system/method having a logo associated therewith that utilizes a specific identification code that is assigned and associated with each and every individual ad. Whereby, when the customer sees the logo they know that the ad is affiliated with the system and also if they wish they can enter the ID code and easily access the ad.

Other objects and advantages will be seen when taken into consideration with the following specification and drawings.

### BRIEF DESCRIPTION OF THE DRAWINGS

FIG. 1 is a flow chart illustrating method steps of operation for a Smartphone customer.

FIG. 2 is a flow chart illustrating method steps of operation for the service provider.

FIG. 3 is a flow chart illustrating method steps of operation for the vendor.

FIG. 4 is a flow chart illustrating the overall operation for the entire system.

### DETAILED DESCRIPTION OF THE DRAWINGS

Referring now in detail to the drawings wherein the method steps of operation are further defined. It is to be understood there are many variables of method steps which may be utilized by the present invention. Thus the following description is only exemplary of some possible variations of use.

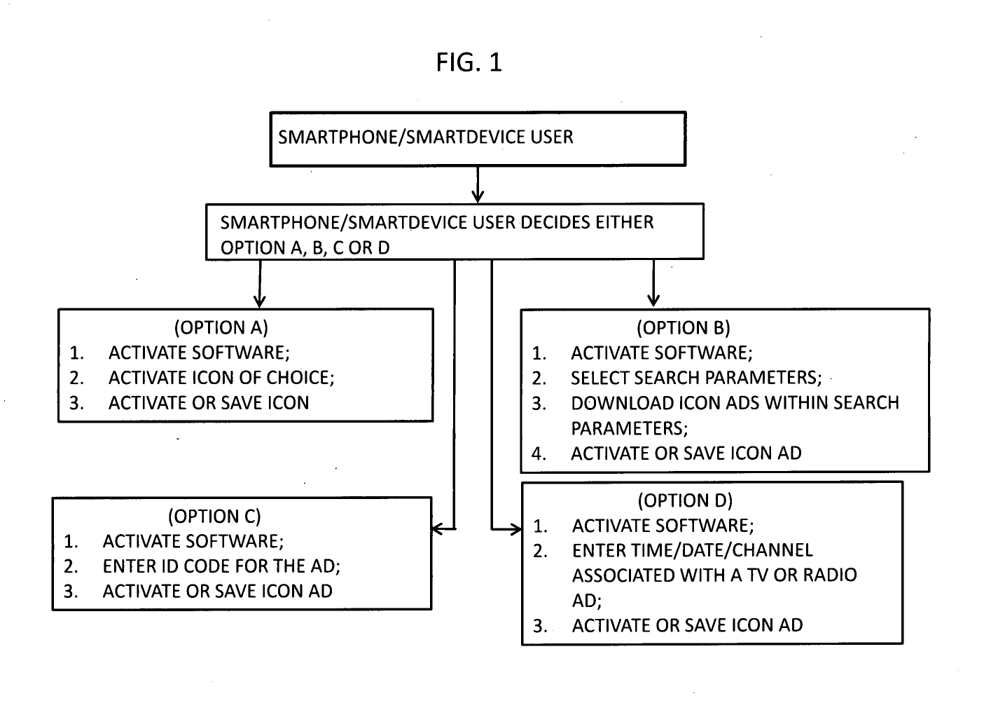

As illustrated in FIG. 1, the user and/or Smartphone/Smart-device customer determines the method of choice for obtaining desired information from an advertisement of their liking. Namely, the customer upon actuation of the Smartphone/Smart-device decides on either one of the following options for interaction;

Option A: The customer see's an ad of which they desire further information. Then they initiate method step (1) and activate the software program of the present invention and either press/touch the one touch ad capture icon. Method step (2) activate the icon of choice and method step (3) either open/activate or save the icon for viewing at a later time when more convenient.

Option B: Method step (1) the customer activates the software program of the present invention. Method step (2) the customer selects search parameters of their choice. Method step (3) downloads icon ads within the search parameters and method step (4) either open/activate any icon of their choosing and/or save the icon for viewing at a later time when more convenient.

Option C: The customer see's an ad having the specialized identification code which is associated and assigned to the specific ad as designated by implication of the present invention. Whereby, then they initiate method step (1) and activate the software program of the present invention. Method step (2) enter the ID code for the ad and method step (3) either open/activate or save the icon for viewing at a later time when more convenient.

Option D: The customer hears an ad on the radio, or see's the ad on TV and they desire more information. Then they initiate method step (1) and activate the software program of the present invention. Method step (2) enter either the time/date/channel “or a combination thereof” associated with the TV or radio ad and method step (3) either open/activate or save the icon for viewing at a later time when more convenient.

Whereby, upon the customer engaging either option (A, B, C OR D) above on their Smartphone/Smart-device, the web portal interface program automatically connects with the service provider/GPS mapping program and the service provider forwards the requested information (advertiser links) to the customer. The customer can then view the ad and/or the web page associated with the advertiser and if further information is desired, the advertiser can be directly contacted via phone, e-mail, text messaging, or visually/verbally via video broadcast, or the like, depending on user choice.

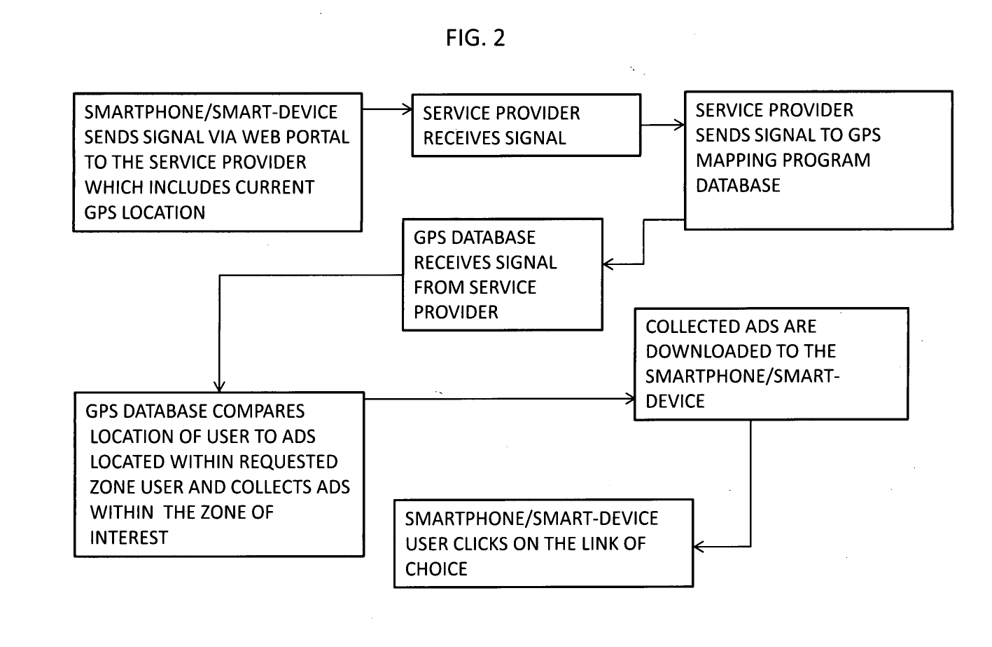

Referring now to FIG. 2, of which depicts the flow chart illustrating the method steps of operation for the service provider.

Method step (1) the Smartphone/Smart-device sends the signal (via the web portal) to the service provider which includes the current GPS location of the user. Method step (2) the service provider receives the signal from the Smartphone/Smart-device. Method step (3) the service provider sends signal to GPS mapping program database. Method step (4) the GPS database receives signal from the service provider. Method step (5) the GPS database compares the location of the user with the ads located within the requested zone and collects ads within the zone of interest. Method step (6) the collected ads are downloaded to the Smartphone/Smart-device and method step (7), the Smartphone/Smart-device user clicks on the advertiser's link of choice or saves the information for viewing at a later time.

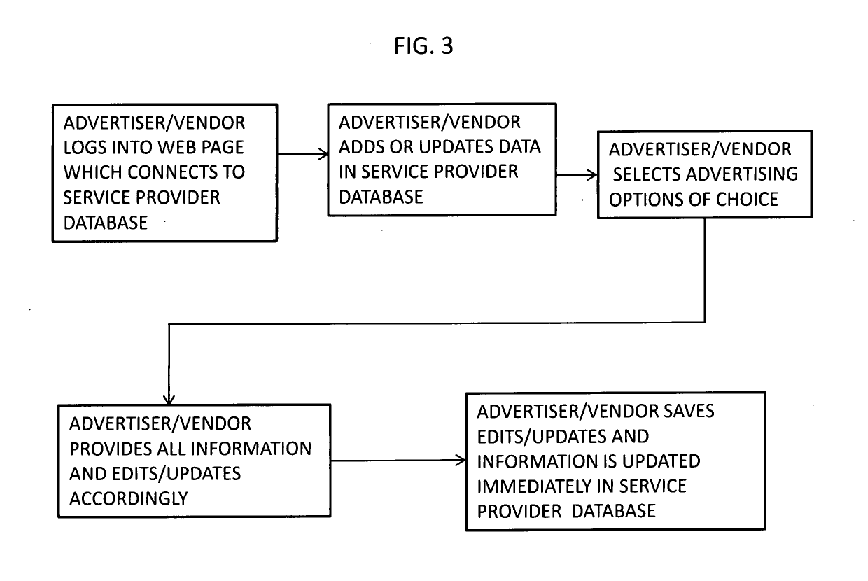

Referring now to FIG. 3, of which depicts the flow chart illustrating the method steps of operation for the vendor.

Method step (1) the advertiser/vendor logs into their web page (via the web portal) which connects to the service provider database. Method step (2) Advertiser/vendor adds or updates data in service provider database. Method step (3) the advertiser/vendor selects advertising options of choice. Method step (4) the advertiser/vendor provides all of the information and edits/updates accordingly and method step (5) the advertiser/vendor saves edits/updates and information is updated immediately in service provider database.

Whereby, the vendor can add numerous options of choice to their ad, such as a direct link to their web page, phone contact, streaming video, live streaming video, live streaming audio, etc. Also, this is very convenient as it allows the vendor to easily update and/or edit any time they wish. Thus, the Smartphone/Smart-device customer is always updated with the most current information in real time. This also allows advertisers to connect and combine all of their advertising efforts.

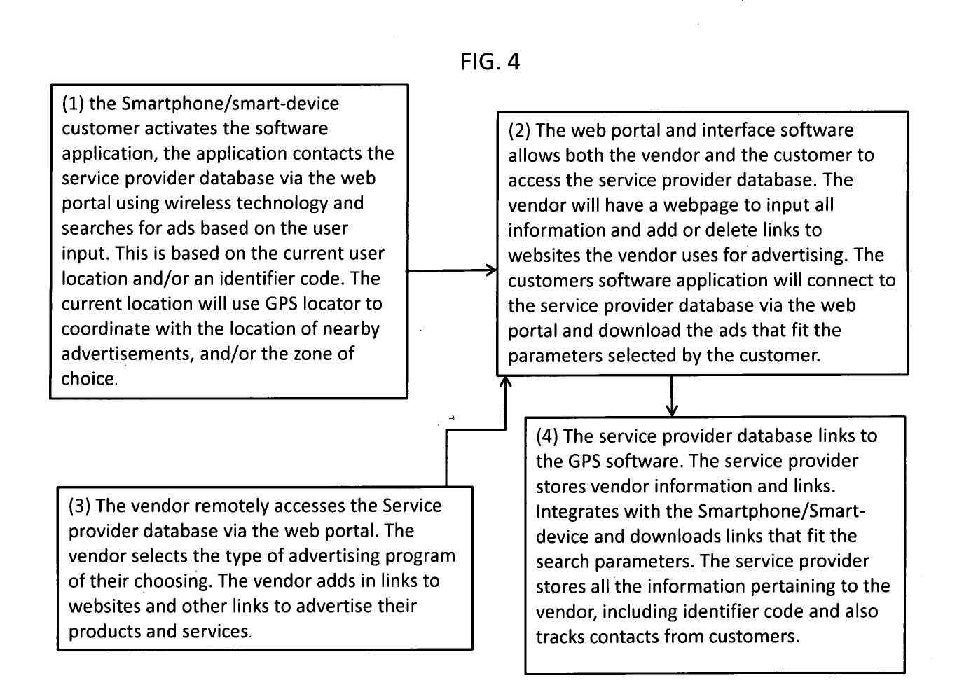

Referring now to FIG. 4, of which depicts the flow chart illustrating the overall operation for the entire system, respectively.

The method of operation comprises: Method step (1) the Smartphone/Smart-device customer activates the Smartphone/Smart-device software application, the software application contacts the service provider database via the web portal using wireless technology and searches for ads based on the user input. This is based on the current user location and/or an identifier code. The current location will use GPS locator to coordinate with the location of nearby advertisements, and/or the zone of choice. Method step (2) the web portal and interface software allows both the vendor and the customer to access the service provider database. The vendor will have a webpage to input all information and add or delete links to websites the vendor uses for advertising. The customer's software application will connect to the service provider database via the web portal and download the ads that fit the parameters selected by the customer. Method step (3) the vendor remotely accesses the Service provider database via the web portal. The vendor selects the type of advertising program of their choosing. The vendor adds in links to websites and other links to advertise their products and services. Method step (4) the service provider database links to the GPS software. The service provider stores vendor information and links. Integrates with the Smartphone/Smart-device and downloads links that fit the search parameters. The service provider stores all the information pertaining to the vendor, including identifier code and also tracks contacts from customers.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

What I claim as new and wish to secure by Letters Patent is:

1. A system/method for wireless internet advertising utilizing GPS location and/or an identifier code via Smartphone/Smart-device interaction, the system including (i) a Smartphone/Smart-device, (ii) a user, (iii) a service provider, (iiii) a GPS mapping program database, (iiii) a web portal/interface, (iiiii) a vendor, (iiiiiii) an advertisement, the system includes options of choice (A), (B), (C) or (D) and said user chooses option (A), the method comprising the steps of:
(a) activating Smartphone/Smart-device;
(b) activating software of the system;
(c) activating an icon of choice and;
(d) activating or saving an icon associated with an advertisement.

2. The system/method of claim 1 wherein said user chooses option (B), the method comprising the steps of:
(a) activating Smartphone/Smart-device;
(b) activating software of the system;
(c) selecting search parameters;
(d) downloading icon ads within said search parameters and;
(e) activating or saving an icon associated with an advertisement.

3. The system/method of claim 1 wherein said user chooses option (C), the method comprising the steps of:
(a) activating Smartphone/Smart-device;
(b) activating software of the system;
(c) entering an identification code corresponding to said advertisement and;
(d) activating or saving an icon associated with said advertisement.

4. The system/method of claim 1 wherein said user chooses option (D), the method comprising the steps of:
(a) activating Smartphone/Smart-device;
(b) activating software of the system;
(c) entering either the time/date/channel or a combination thereof associated with either a TV or radio advertisement; and
(d) activating or saving an icon associated with said advertisement.

5. A system/method for wireless internet advertising utilizing GPS location and/or an identifier code via Smartphone/Smart-device interaction, the system including (i) a Smartphone/Smart-device, (ii) a user, (iii) a service provider, (iiii) a GPS mapping program database, (iiiii) a web portal/interface, (iiiiii) a vendor, and (iiiiiii) an advertisement, the method comprising the steps of:
(a) said service provider receives signal from said Smartphone/Smart-device via said web portal;
(b) said service provider sends signal to said GPS mapping program database;
(c) said GPS mapping program database receives signal from said service provider;
(d) said GPS mapping program database compares location of said user to ads located within requested zone;
(e) said GPS mapping program database collects said ads located within requested zone;
(f) said ads located within requested zone are downloaded to said Smartphone/Smart-device; and
(g) said user clicks on the link of choice.

6. The system/method of claim 5 further includes the method steps comprising:
(h) said vendor logs into their web page via said web portal which connects to said service provider database;
(i) said vendor adds or updates data in said service provider database;
(j) said vendor selects advertising options of choice;
(k) said vendor provides all of the information and edits/updates accordingly; and
(l) said vendor saves edits/updates and information is updated immediately in said service provider database.

7. The system of claim 1 further includes said user activating said system via voice commands.
